(19) United States
(12) Patent Application Publication
(10) Pub. No.: US 2011/0246965 A1
(43) Pub. Date: Oct. 6, 2011

(54) CORRECTING DOCUMENT GENERATION FOR POLICY COMPLIANCE

(75) Inventors: MICHAEL ANTHONY STRACK, Round Rock, TX (US); Allen Keith Wilson, Austin, TX (US); Shunguo Yan, Austin, TX (US)

(73) Assignee: International Business Machines Corporation, Armonk, NY (US)

(21) Appl. No.: 12/752,676

(22) Filed: Apr. 1, 2010

(51) Int. Cl. G06F 11/07; G06F 9/44

(52) U.S. Cl. 717/124; 714/15; 714/E11.023

(57) ABSTRACT

A method, system, and computer usable program product for correcting document generation for policy compliance are provided in the illustrative embodiments. An error is detected in an electronic document at a first application. A code location associated with the error is identified. The electronic document has embedded debugging code including a set of code locations including the code location. An input is received, the input being usable in correcting the error. An information usable in correcting the error is created, the information including the input. The information is sent to a second application executing in a second data processing system. The information is usable to modify a third application.

### RELATED APPLICATIONS

The present invention is related to similar subject matter of co-pending and commonly assigned U.S. patent application Ser. No. 12/391,013 (Attorney Docket No. AUS920080815US1) entitled “DOCUMENT SOURCE DEBUGGER,” filed on Feb. 23, 2009, which is hereby incorporated by reference.

### BACKGROUND OF THE INVENTION

1. Field of the Invention

The present invention relates generally to an improved data processing system, and in particular, to a computer implemented method for improving data security. Still more particularly, the present invention relates to a computer implemented method, system, and computer usable program code for correcting document generation for policy compliance.

2. Description of the Related Art

Data processing systems communicate with each other over a data network by exchanging electronic documents. Often, these electronic documents are dynamically generated by computer programs or applications rather than being static content. Furthermore, some electronic documents are generated through a collaboration of several applications, where each application or an application component might contribute a piece of the information in the electronic document. For example, Hypertext Markup Language (HTML) pages are often dynamically generated by executing server side applications or application components, such as JavaServer Pages (JSP), Servlet or Portlet.

Data security is a concern in data processing environments. Typically, data leaving the data processing environment should comply with the security requirements of the data processing environment. The security requirements are typically implemented as security policies or rules in data processing environments. Similarly, security concerns arise with respect to the data that enters the data processing environment.

Other concerns also exist with respect to the data being exchanged in the form of electronic documents in a data processing environment. For example, electronic documents are often required to comply with corporate governance or industry-specific guidelines for quality control and accessibility. Data processing environments may include policies that specify the compliance requirements for these and other such considerations as well. Ideally, an electronic document that is generated in a data processing environment should be compliant with all applicable policies.

### SUMMARY OF THE INVENTION

The illustrative embodiments provide a method, system, and computer usable program product for correcting document generation for policy compliance. An embodiment detects, at a first application executing in a first data processing system, an error in an electronic document. The embodiment identifies an code location associated with the error. The electronic document has embedded debugging code including a set of code locations, the code location being a code location in the set of code locations. The embodiment receives an input, the input being usable in correcting the error. The embodiment creates information usable in correcting the error, the information including the input. The embodiment sends the information to a second application executing in a second data processing system. The information is usable to modify a third application.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of generating an electronic document with respect to which an illustrative embodiment may be implemented;

FIG. 4 depicts a block diagram of a configuration to correct document generation for policy compliance in accordance with an illustrative embodiment;

FIG. 5 depicts an example client-side configuration for correcting document generation for policy compliance in accordance with an illustrative embodiment;

FIG. 6 depicts a block diagram of an example information that is usable for correcting document generation in accordance with an illustrative embodiment;

FIG. 7 depicts an example server-side configuration for correcting document generation for policy compliance in accordance with an illustrative embodiment;

FIG. 8 depicts a block diagram of another example server-side configuration for correcting document generation for policy compliance in accordance with an illustrative embodiment;

FIG. 9 depicts a flowchart of a process of providing information usable in correcting document generation for policy compliance in accordance with an illustrative embodiment; and

FIG. 10 depicts a flowchart of a process of correcting document generation for policy compliance in accordance with an illustrative embodiment.

### DETAILED DESCRIPTION OF THE PREFERRED EMBODIMENT

An electronic document is any organization of data according to some structure. An electronic document may be machine readable, human readable, or both. An entire electronic document or a part of an electronic document is an electronic document, generated document, or generated electronic document, within the scope of this disclosure.

An application or an application component of any kind that contributes, generates, creates, compiles, arranges, transforms, translates, computes, modifies, or otherwise manipulates data in an electronic document is a generation application within the scope of this disclosure. The process of generating an electronic document using a generation application is called document generation.

The invention recognizes that policy compliance violations may be introduced in an electronic document when the document is created by an application. In some instances, remedying the violations may be possible by capturing each electronic document, identifying a policy violation therein, and correcting the violation in that copy of the electronic document.

The invention further recognizes, however, that such a method of ensuring policy compliance is not effective for several reasons. For example, a large number of electronic documents may be generated in a data processing environment. Of those electronic documents, only a fraction may include a policy violation. Furthermore, there may be many copies of an electronic document in that fraction, such as copies distributed to browsers on a number of client computers.

The invention recognizes that correcting the violation document-by-document in this manner corrects the violation only in a copy of the electronic document. The corrective process has to be repeated for each copy. The corrections are lost when a corrected copy is refreshed, requiring a re-application of the corrections.

The invention recognizes that a more effective way to correct policy violations in electronic documents is to correct the generation applications. Electronic documents generated from thus corrected generation applications will not include the policy violation

Some presently used document authoring tools include checking facilities that help users identify and correct compliance errors. However, the invention recognizes that in the case of generated documents, these tools cannot trace an error back to the generating application or the source of the error within that application.

The invention further recognizes another problem with the document authoring tools, particularly for web pages. A web page is an electronic document generated at a web server and served to a client application, such as a web browser. Existing tools may analyze a website on a page-by-page basis after the page is rendered on the client. Web pages often are dynamically composed by applying page-specific content to a site-wide template.

As in the case of a generated document, the checking facilities of the tools cannot trace errors back to the template or to the page specific content. The invention recognizes that when the error is in the template, a page-by-page fix is not effective because the template may have to be updated to remove the error from future generated documents.

Some other existing tools may help users correct errors by asking user to input corrections and then merging the corrections into a copy of an electronic document. Such existing tools are usually embedded or installed in a user's browser or document editor, and corrections are directly applied to local copy of the electronic document.

However, the invention recognizes that when a document is dynamically generated or assembled from multiple sources, the corrections applied in this manner may be only available in the user's local copy of the document. Such corrections are not available to other users who may receive another copy of the same document. Furthermore, if the corrected copy document is reloaded even in the same user's browser, the corrections may be lost.

A third approach used by some other existing programs is to embed code into a web page to dynamically modify the page and fix particular compliance errors. The invention recognizes that in such cases, given the differences in the structures and contents of the various pages in a site, the code has to be unique to each page, must run each time a page is loaded, and must be updated when a page changes. The invention recognizes that such management of code is complex, time consuming, and error prone.

Some existing applications scan the source code of a program that generates dynamic documents in an attempt to identify compliance errors. However, the invention recognizes that identifying all incompliance errors that could appear in a generated document is difficult, inefficient, and not reliable according to this method. The invention recognizes that this method of detecting compliance errors is undesirable or ineffective because the complexity of compliance guidelines and standards may be difficult to manage in this way, and because an application can be designed and coded in a very large number of different ways to generate the exact same document.

The illustrative embodiments used to describe the invention generally address and solve the above-described problems and other problems related to policy compliance in document generation. The illustrative embodiments provide a method, computer usable program product, and data processing system for correcting document generation for policy compliance.

The illustrative embodiments are described with respect to data, data structures, and identifiers only as examples. Such descriptions are not intended to be limiting on the invention. For example, an illustrative embodiment described with respect to an HTML page may be implemented using an extensible Markup Language (XML) page in a similar manner within the scope of the invention.

Furthermore, the illustrative embodiments may be implemented with respect to any type of data processing system. For example, an illustrative embodiment described with respect to a standalone data processing system may be implemented in a logical partition system within the scope of the invention.

The illustrative embodiments are further described with respect to certain parameters, attributes, and configurations only as examples. Such descriptions are not intended to be limiting on the invention. An embodiment of the invention may be implemented with respect to any type of data processing system, such as, for example, any type of client system, server system, platform, or a combination thereof.

An application implementing an embodiment may take the form of data objects, code objects, encapsulated instructions, application fragments, services, and other types of software implementations available in a data processing environment. For example, Java® Virtual Machine (JVM®), Java® object, an Enterprise Java Bean (EJB®), a servlet, or an applet may be manifestations of an application with respect to which, within which, or using which, the invention may be implemented. (Java, JVM, EJB, and other Java related terminologies are registered trademarks of Sun Microsystems, Inc. in the United States and other countries.)

An illustrative embodiment may be implemented in hardware, software, or a combination thereof. The examples in this disclosure are used only for the clarity of the description and are not limiting on the illustrative embodiments. Additional or different information, data, operations, actions, tasks, activities, and manipulations will be conceivable from this disclosure for similar purpose and the same are contemplated within the scope of the illustrative embodiments.

The illustrative embodiments are described using specific code, data structures, file systems, designs, architectures, layouts, schematics, and tools only as examples and are not limiting on the illustrative embodiments. Furthermore, the illustrative embodiments are described in some instances using particular data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

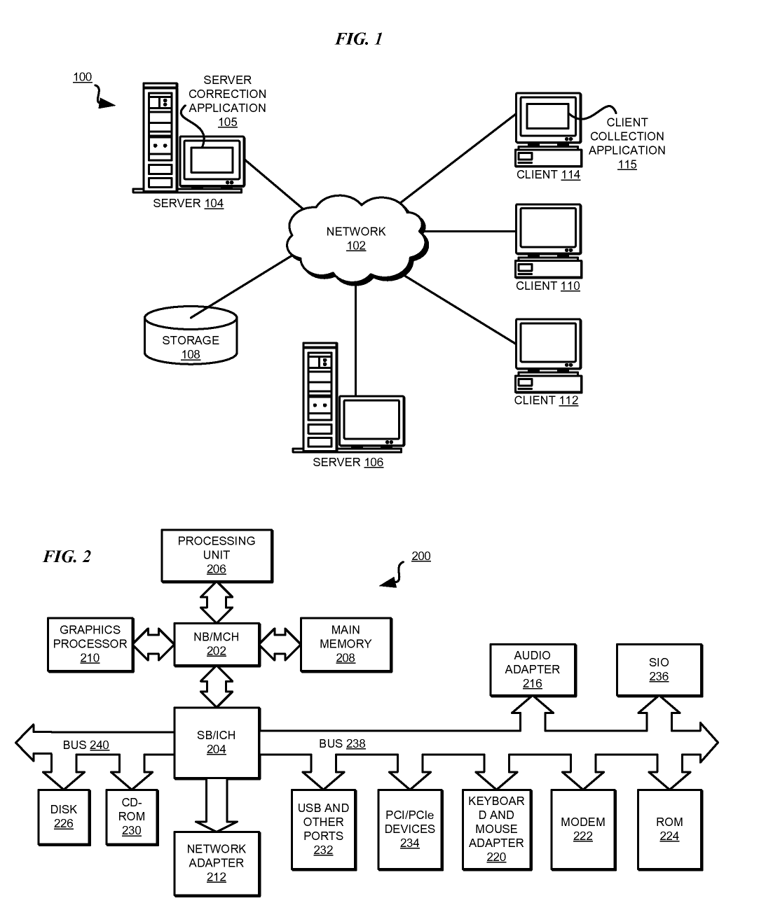

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may include application 105. Application 105 may be a server correction application as described elsewhere in this disclosure. Client 114 may include application 115. Application 115 may be a client collection application as described elsewhere in this disclosure.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft° Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

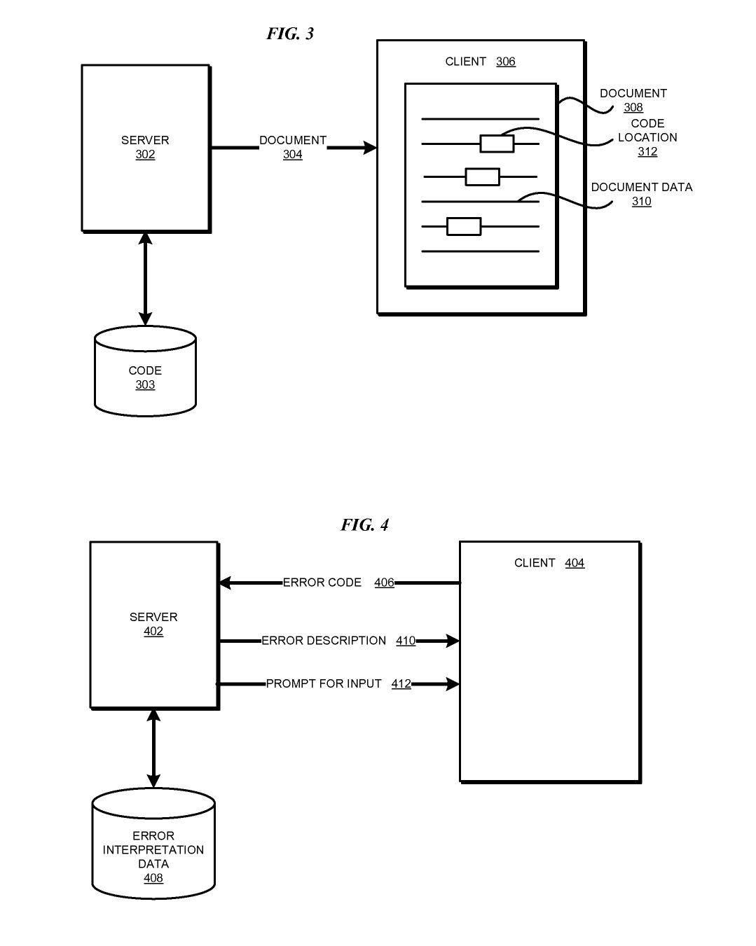

With reference to FIG. 3, this figure depicts a block diagram of generating an electronic document with respect to which an illustrative embodiment may be implemented. Server 302 may be a data processing system similar to server 104 in FIG. 1.

Code 303 may be code for one or more generating applications. Server 302 uses code 303 to generate document 304. Code 303 may be stored anywhere in a data processing environment, such as in a data storage device accessible to server 302.

Document 304 may be an electronic document. Server 302 presents document 304 to client 306. Client 306 may be data processing system, such as client 114 in FIG. 1.

Document 304 may be presented as document 308 at client 306. Document 308 includes data 310 and code location 312. A code location is an identifier of a location in a source code, such as a combination of a source program name and line number, which generated a piece of data in the document. As described elsewhere in the related disclosure, debugging code may be embedded in document 308 and the debugging code may include code location 312. Any number of code locations 312 may be included in document 308 in this manner within the scope of the invention.

In one embodiment, document 304 may be an HTML page. A process at client 306 may receive document 304 and validate the page. The validation process at client 306 may create a report, such as an accessibility report, that may include one or more code locations 312, and one or more error codes. An error code uniquely identifies an error in a document. Combination of an error location and error code identifies the same error in multiple locations.

With reference to FIG. 4, this figure depicts a block diagram of a configuration to correct document generation for policy compliance in accordance with an illustrative embodiment. Server 402 may be similar to server 302 in FIG. 3. Client 404 may be similar to client 306 in FIG. 3.

Error code 406 may be one or more error codes received from a validation report as described with respect to FIG. 3. Client 404 sends error code 406 to server 402. For example, in one embodiment, client 404 may receive one or more error codes in a report, such as a validation report. Client 404 may select one or more of those received error codes to send as error code 406.

Server 402 receives error code 406 and uses error interpretation data 408 to extract error description 410. Error interpretation data 408 may be information usable for decoding an error code, correlating an error code with additional information, or mapping an error code to an event or condition.

For example, in one embodiment, error interpretation data 408 may be a plain text human comprehensible meaning of the error indicated by error code 406. Server 402 may use the plain text to form error description 410.

In another embodiment, error interpretation data 408 may be code that should be sent or executed in response to error code 406. In one embodiment, server 402 may execute or otherwise use such code to generate error description 410. In another embodiment, server 402 may send such code as error description 410 and client 404 may execute or otherwise use the code.

Server 402 may also send prompt 412 to client 404. Prompt 412 may be code, text, indicator, or any form of data usable at client 404 for soliciting an input from an application.

For example, in one embodiment, prompt 412 may be code for a popup window with a data input field. The data input field in the popup window may seek input from a user.

In another embodiment, prompt 412 may be code to invoke an application. For example, prompt 412 in such an embodiment may cause a browser to invoke a database query at the data processing system where client 404 may be executing. As another example, prompt 412 may cause the browser to invoke an application programming interface (API) of another application executing in the data processing system of client 404.

In one embodiment, error description 410 and prompt 412 may be combined. For example, error interpretation data 408 may be code that server 402 sends to client 404. The code may include error description 410 as well as information sufficient to perform a function of prompt 412.

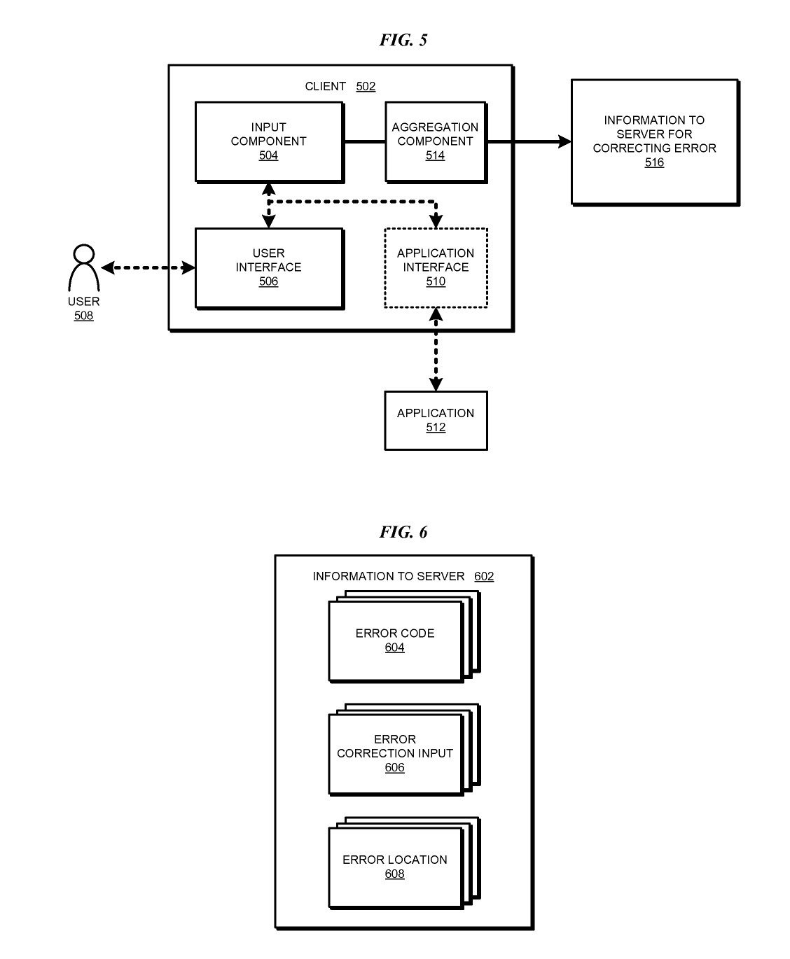

With reference to FIG. 5, this figure depicts an example client-side configuration for correcting document generation for policy compliance in accordance with an illustrative embodiment. Client 502 may be similar to client 404 in FIG. 4.

Client 502 may include input component 504. Input component 504 may be responsible for collecting inputs in response to a prompt from a server, such as prompt 412 in FIG. 4. For example, input component 504 may utilize user interface component 506 to receive input from user 508. As another example, input component 504 may use application interface 510 to receive input from application 512. Application 512 may be any application accessible to client 502, such as over a data network.

Input component 504 may communicate the received inputs, such as inputs from a combination of user 508 and application 512, to aggregation component 514. Aggregation component 514 may combine, organize, arrange, transform, or otherwise manipulate one or more inputs received from input component 504.

For example, a server may send several prompts to client 502 for one or more electronic documents associated with a site that client 502 may be accessing. Input component 504 may collect more than one input from a combination of user 508 and one or more applications 512. In an example configuration, client 502 may accumulate inputs for a set of the electronic documents associated with a site such that the accumulated inputs can be communicated together to the server. A set of electronic documents is one or more documents.

Information 516 is information usable at a server for correcting document generation for policy compliance. For example, in one embodiment, client 502 may send aggregated inputs as information 516. In another embodiment, client 502 may manipulate the aggregated inputs and send transformed aggregated inputs as information 516. Information 516 may take any form suitable for a particular implementation within the scope of the invention. Furthermore, information 516 may not be limited to just the inputs, and may include additional information without departing the scope of the invention.

The components depicted in FIG. 5 are only depicted as such for the description of their respective functions and are not limiting on the invention. Furthermore, the depicted components or the function thereof may be implemented as a client-side information collection application, such as client collection application 115 in FIG. 1.

With reference to FIG. 6, this figure depicts a block diagram of an example information that is usable for correcting document generation in accordance with an illustrative embodiment. Information 602 may be usable as information 516 in FIG. 5.

Information 602 may be prepared by a client, such as client 502 in FIG. 5. Information 602 may be prepared in response to one or more errors or violations of one or more policies in one or more electronic documents. Information 602 may be sent to a server, such as server 402 in FIG. 4, where one or more of those electronic documents may be generated.

In the example information depicted in FIG. 6, information 602 may include a set of error codes 604, a set of error correction inputs, and a set of error locations 608. A set of error codes is one or more error codes a set of error correction inputs is one or more error correction inputs. A set of error locations is one or more error locations. As described elsewhere in the disclosure, a location of an error is provided by the debugging code or an equivalent thereof that is embedded in an electronic document.

Multiple error codes may identify or relate to a common error. Accordingly, set of error codes 604 may include a subset of error codes that may identify a common error. Multiple error correction inputs may relate to a common error. Accordingly, set of error correction inputs 606 may include a subset of error correction inputs that may remedy a common error.

Multiple errors may be located at a common location in an electronic document. Multiple electronic documents may include a common error. An electronic document may include a common error in multiple locations. All combinations of errors, error corrections, error locations, and electronic documents are contemplated in information 602.

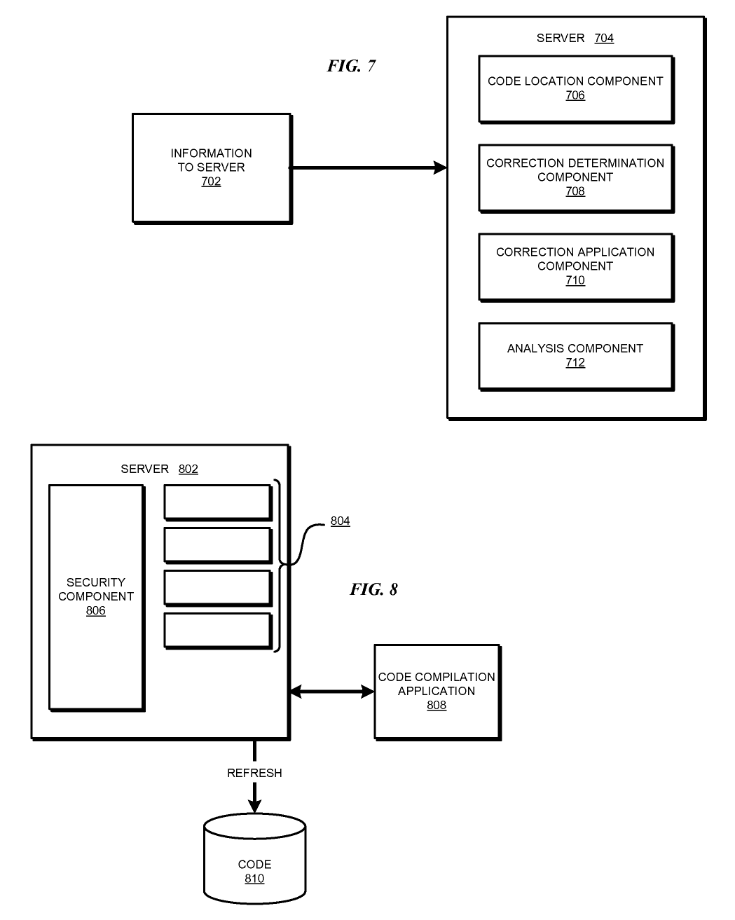

With reference to FIG. 7, this figure depicts an example server-side configuration for correcting document generation for policy compliance in accordance with an illustrative embodiment. Information 702 may be similar to information 602 in FIG. 6. Server 704 may be similar to server 402 in FIG. 4.

Server 704 may receive information 702 from a client, such as client 502 in FIG. 5. Server 704 may include code location component 706. Code location component 706 may use a portion of information 702, such as error location 608 in FIG. 6, for locating an error. For example, code location component 706 may locate one or more segments of code that generate the portion of the electronic document where a particular error may lie. Code location component 706 may further locate a cause of error in such code, such as a particular line of code.

Code location component 706 may be configured to locate a cause of error at any granularity within the scope of the invention. For example, in one embodiment, component 706 may locate a method in a class as a cause of error. In another embodiment, component 706 may locate a line of code in one generating application and a function in another generating application. The example granularities of code locations are selected and described only for the clarity of an embodiment and are not intended to be limiting on the invention.

Correction determination component 708 determines what part of the code located by code location component 706 should be corrected to correct the policy compliance issue. For example, an electronic document may have a policy compliance error that may allow a client to copy a portion of an electronic document in violation of a copyright agreement. An error correction input in information 702 may include a notation, “disable copy” for that error. Correction determination component 708 may determine that the right-click menu for a certain area of the electronic document should be modified to disable the “copy” function. The code responsible for generating that area of the electronic document may be identified by code location component 706.

Correction application component 710 may apply a correction to a document generation application. For example, one correction may require that a line of code be changed in a generation application. As another example, another correction may call for replacing one function call with a different function call. Other example corrections may be changing permissions of a file, scope of data, change in a configuration of a generation application, or changing a behavior of a data processing system component.

Analysis component 712 may be called upon to analyze code, operation, or behavior of a generation application. In other words, analysis component 712 may analyze a generation application code or data so that code location component 706 may suitably locate the source of an error, correction determination component 708 may determine a suitable correction, correction application component 710 may suitably apply a correction, or a combination of components in server 704 may suitably perform their respective functions.

Analysis component 712 may also determine other generation applications that may be affected by corrective measure to correct a policy compliance issue. For example, analysis component 712 may determine that a policy management system should be reconfigured in addition to a code correction in a generation application for adequately addressing a policy compliance violation.

The components depicted in FIG. 7 are only depicted as such for the description of their respective functions and are not limiting on the invention. Furthermore, the depicted components or the function thereof may be implemented as a server-side correction application, such as server correction application 105 in FIG. 1.

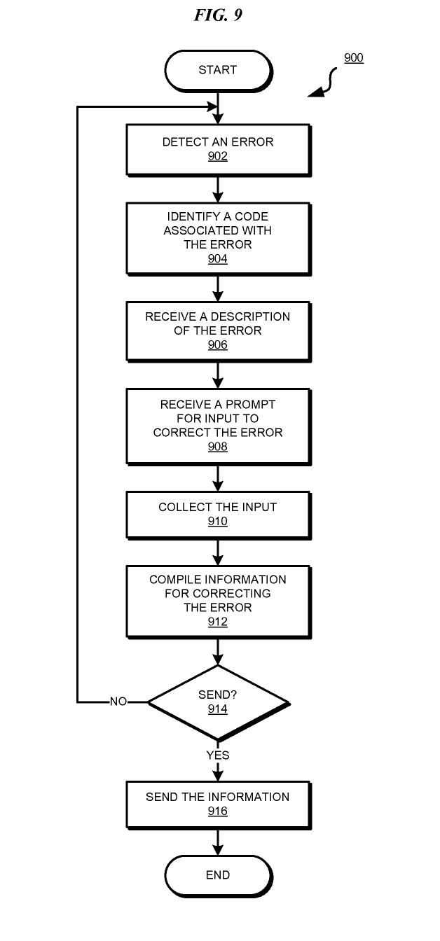

With reference to FIG. 8, this figure depicts a block diagram of another example server-side configuration for correcting document generation for policy compliance in accordance with an illustrative embodiment. Server 802 may be similar to server 704 in FIG. 7. Server 802 may include components 804, which may include components 706-712 in FIG. 7.

Server 802 may further include security component 806. Security component 806 may perform any authentication, authorization, verification, validation, or filtering functions. For example, such functions may be used to ensure that the error correction inputs received from a client do not introduce policy violations on their own. For example, an error correction input from one application may be deemed reliable whereas a similar input from another application may not.

A component in server 802, such as one of components 804, may be configured to interface with code recompilation application 808. For example, correction application component 710 in FIG. 7 may be such a component 804. After applying a correction, the component may call code recompilation application 808 if the resulting changed code has to be recompiled. Code recompilation application 808 may be substituted with any post-correction process within the scope of the invention.

Server 802 or a component thereof may refresh code repository 810 with the corrected code. For example, in one embodiment, recompiled code may be saved to code repository 810. In another embodiment, a modified data file may be saved to code repository 810. In another embodiment, a changed configuration of a generating application may be saved to code repository 810.

With reference to FIG. 9, this figure depicts a flowchart of a process of providing information usable in correcting document generation for policy compliance in accordance with an illustrative embodiment. Process 900 may be implemented in a client, such as in client 502 in FIG. 5.

Process 900 begins by detecting an error in an electronic document (step 902). Process 900 identifies a code, such as an error code, associated with the error (step 904).

Process 900 may receive a description of the error based on the error code (step 906). An implementation may omit step 906 without departing the scope of the invention.

Process 900 receives a prompt for input to correct the error (step 908). An implementation may receive any information that is usable as a prompt, usable for creating a prompt, or usable for causing an input according to an embodiment, within the scope of the invention.

Process 900 collects the input in response to the prompt of step 908 (step 910). Process 900 compiles the information for correcting the error (step 912). In one embodiment, the compilation of information in step 912 may be similar to the operation of aggregation component 514 in FIG. 5.

Process 900 determines whether the information is ready to be sent to a server (step 914). The information may not be ready for sending, for example, when a client collection application is configured to provide the information for a set of electronic documents and not document-by-document. If the information is not ready for sending (“No” path of step 914), process 900 returns to step 902.

If the information is ready for sending (“Yes” path of step 914), process 900 sends the information to a server of an electronic document (step 916). Process 900 ends thereafter.

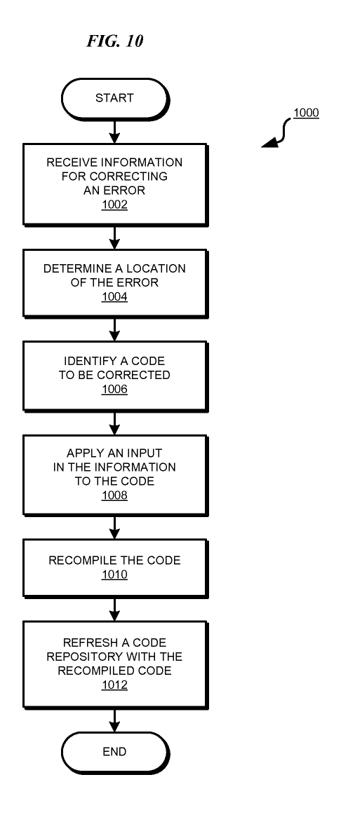

With reference to FIG. 10, this figure depicts a flowchart of a process of correcting document generation for policy compliance in accordance with an illustrative embodiment. Process 1000 may be implemented in a server, such as server 802 in FIG. 8.

Process 1000 begins by receiving information for correcting an error (step 1002). Process 1000 determines a location of the error (step 1004). Process 1000 identifies a code to be corrected to remedy the error (step 1006). Process 1000 applies an error correction input from the information to the code (step 1008).

Process 1000 may recompile the corrected code (step 1010). Process 1000 refreshes a code repository with the recompiled code (step 1012). Process 1000 ends thereafter.

In one embodiment, process 1000 may perform another post-correction processing instead of or in conjunction with the recompilation of step 1010. An implementation may omit step 1010 without departing the scope of the invention. Refreshing of a code repository may not be needed in certain implementations. Accordingly, step 1012 may be omitted within the scope of the invention.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Thus, a computer implemented method, apparatus, and computer program product are provided in the illustrative embodiments for correcting document generation for policy compliance. Using the embodiments of the invention, a data processing system can correct a source of an error in a generated document. Using an embodiment, a correction can be applied such that the correction applies to all copies of an electronic document including refreshed copies of the document.

Furthermore, an embodiment may be used such that multiple users or applications can provide complementary or contradictory correction inputs for the same error. An embodiment may employ any selection criteria for selecting a preferred correction input from several correction inputs, or for combining multiple complimentary correction inputs.

An embodiment may be configured to accept one error correction input, perform an error correction based on that input, and publish a corrected document. The embodiment may then continue to embed debugging code with the same or different error codes for the already corrected error so that more users or applications can provide alternate corrections or refine the existing corrections.

An embodiment may not solicit input from a user or application but may enable a client or a server to automatically generate an error correction input. For example, a client may receive a prompt and determine that a component of the client can generate an error correction. The client may then provide the input from that component instead of soliciting an input from a user or an application.

An embodiment may allow a server to evaluate the effects of an error correction before refreshing a code repository with the corrected code. For example, an embodiment may include a unit testing step before the recompiled code is refreshed in the repository.

The embodiments of the invention can collaborate with existing client and server applications. For example, an embodiment can be implemented in conjunction with an existing web server or a web browser.

The invention can take the form of an entirely software embodiment, or an embodiment containing both hardware and software elements. In a preferred embodiment, the invention is implemented in software or program code, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for correcting document generation for policy compliance, the computer implemented method comprising:
detecting, at a first application executing in a first data processing system, an error in an electronic document;
identifying a code location associated with the error, the electronic document having embedded debugging code including a set of code locations, the code location being a code location in the set of code locations;
receiving an input, the input being usable in correcting the error;
creating information usable in correcting the error, the information including the input; and
sending the information to a second application executing in a second data processing system, the information being usable to modify a third application.

2. The computer implemented method of claim 1, further comprising:
identifying the third application whose code has to be modified to correct the error;
identifying a location in the code of the third application, code at the location being the cause of the error, and the location in the code corresponding to the code location in the information; and
modifying the code at the location by applying the input from the information to form modified code.

3. The computer implemented method of claim 2, further comprising:
refreshing a code repository with the modified code.

4. The computer implemented method of claim 3, further comprising:
recompiling the modified code to form recompiled code, wherein the refreshing is performed with the recompiled code.

5. The computer implemented method of claim 2, wherein the location is derivable from debugging data embedded in the electronic document.

6. The computer implemented method of claim 2, wherein the code of the third application is data used by the third application, and the location in the code is a location of error-causing data in the data used by the third application.

7. The computer implemented method of claim 1, wherein the information further includes a set of error codes.

8. The computer implemented method of claim 1, wherein the error is a violation of a policy, further comprising:
receiving a description of the error in response to sending the error code to the second application.

9. The computer implemented method of claim 1, further comprising:
receiving a prompt at the first application from the second application, wherein receiving the input is responsive to the prompt.

10. The computer implemented method of claim 9, wherein the prompt is code that is executable to cause the first application to invoke a fourth application.

11. A computer usable program product comprising a computer usable storage medium including computer usable code for correcting document generation for policy compliance, the computer usable code comprising:
computer usable code for detecting, at a first application executing in a first data processing system, an error in an electronic document;
computer usable code for identifying a code location associated with the error, the electronic document having embedded debugging code including a set of code locations, the code location being a code location in the set of code locations;
computer usable code for receiving an input, the input being usable in correcting the error;
computer usable code for creating information usable in correcting the error, the information including the input; and
computer usable code for sending the information to a second application executing in a second data processing system, the information being usable to modify a third application.

12. The computer usable program product of claim 11, further comprising:
computer usable code for identifying the third application whose code has to be modified to correct the error;
computer usable code for identifying a location in the code of the third application, code at the location being the cause of the error, and the location in the code corresponding to the code location in the information; and
computer usable code for modifying the code at the location by applying the input from the information to form modified code.

13. The computer usable program product of claim 12, wherein the location is derivable from debugging data embedded in the electronic document.

14. The computer usable program product of claim 12, wherein the code of the third application is data used by the third application, and the location in the code is a location of error-causing data in the data used by the third application.

15. The computer implemented method of claim 11, wherein the information further includes a set of error codes.

16. The computer usable program product of claim 11, wherein the computer usable code is stored in a computer readable storage medium in a data processing system, and wherein the computer usable code is transferred over a network from a remote data processing system.

17. The computer usable program product of claim 11, wherein the computer usable code is stored in a computer readable storage medium in a server data processing system, and wherein the computer usable code is downloaded over a network to a remote data processing system for use in a computer readable storage medium associated with the remote data processing system.

18. A data processing system for correcting document generation for policy compliance, the data processing system comprising:
a storage device including a storage medium, wherein the storage device stores computer usable program code; and
a processor, wherein the processor executes the computer usable program code, and wherein the computer usable program code comprises:
computer usable code for detecting, at a first application executing in a first data processing system, an error in an electronic document;
computer usable code for identifying a code location associated with the error, the electronic document having embedded debugging code including a set of code locations, the code location being a code location in the set of code locations;
computer usable code for receiving an input, the input being usable in correcting the error;
computer usable code for creating information usable in correcting the error, the information including the input; and
computer usable code for sending the information to a second application executing in a second data processing system, the information being usable to modify a third application.

19. The data processing system of claim 18, further comprising:
computer usable code for identifying the third application whose code has to be modified to correct the error;
computer usable code for identifying a location in the code of the third application, code at the location being the cause of the error, and the location in the code corresponding to the code location in the information; and
computer usable code for modifying the code at the location by applying the input from the information to form modified code.

20. The data processing system of claim 19, wherein the location is derivable from debugging data embedded in the electronic document.
